(19) United States
(12) Patent Application Publication
(10) Pub. No.: US 2010/0208859 A1
(43) Pub. Date: Aug. 19, 2010

(54) DEGASSING VALVE AND CHECK VALVE COMBINATION

(76) Inventor: Lambros LOIS, Potomac, MD (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/698,179

(22) Filed: Feb. 2, 2010

Related U.S. Application Data
(60) Provisional application No. 61/202,172, filed on Feb. 3, 2009.
(60) Provisional application No. 61/247,621, filed on Oct. 1, 2009.

(51) Int. Cl. G21C 9/00; G05D 7/00

(52) U.S. Cl. 376/282; 137/613; 137/614.2

(57) ABSTRACT

A venting-valve/check-valve combination useful for venting non-condensable gases and steam (or a combination) in a liquid pipeline comprises a venting-valve, a check-valve, and a capillary port through which gas can pass, said port having two openings, each valve controlling the opening and closing of one of said openings.

This Application claims benefit of U.S. Provisional Application 61/202,172 of Feb. 3, 2009, and U.S. Provisional Application 61/247,621 of Oct. 1, 2009, both of which are incorporated by reference herein.

### BACKGROUND OF THE INVENTION

Nuclear power plants are equipped with stand-by emergency systems designed to inject cold water into the reactor core to remove decay heat. However, in such stand-by systems where water may be stagnant for prolonged periods of time, air, non-condensable gases, steam, or a combination thereof (herein collectively called “gases”) could accumulate in the piping; pump casings, valves or other structural elements. Sizable bubbles of accumulated gases in such systems could prove destructive to the system as well as to the plant itself.

Gases are introduced in the plant's emergency cooling water by one or more of the following ways: (a) components of atmospheric air are dissolved in the water; (b) air gets trapped in the intake in the form of air bubbles, air pockets or by vortexing; (c) air sips-in from faulty contiguous systems at higher pressure; or (d) steam could be produced in the system itself when a system surface is in contact with high temperature components, elevating water temperature above the boiling point corresponding to the system pressure. Gases, in the form of dissolved air or air bubbles or steam in stagnant water in newly filled pipes will coalesce to bigger bubbles and create void(s) at the highest elevation (or local high elevations) of the system. Emanation of gases is favored by temperature and pressure changes.

In the stand-by emergency water injection system we distinguish the portions of the system downstream and upstream from the pump that is designed to inject water into the core. The pump normally is of a single or multiple stage centrifugal design. If the pump is activated with gas bubbles in the system (a) upstream from the pump, the bubble will reach the pump and either the pump could be damaged (or destroyed) from imbalanced operation or achieve only partial flow and pressure, or (b) downstream, the accelerating water slug could reach a pipe turn, a valve or other structural obstruction with the potential to damage the pipe, pipe supports or other system components due to momentum transfer. Such instances could be damaging to the plant not only due to loss of the pump and/or its piping but mainly because the pump will not be able to carry out its safety function. In the presence of steam (or air steam mixture) the accelerating water slug due to steam condensation could amass more kinetic energy and become even more destructive.

As in all contemporary power generation units, in nuclear power plants reliability of system and component performance is of paramount importance. System and/or component failure may have consequences well beyond the value of the component and perhaps the value of the plant.

Current gas venting practice in nuclear power plant emergency response systems uses conventional manually operated valves similar to those used in hydraulic systems for management of fluid flow. Such valves are installed on pipes that constitute part of the flow path, are of large size compared to the vent-valve check-valve of this invention, are operated manually, are expensive, and require maintenance. In current practice cost prevents redundancy of venting valves and manual operation increases operational costs and allows time intervals with the potential of gas bubble formation in the system.

Current gas venting practice is not satisfactory because between venting intervals gas bubbles have been found in emergency response systems that could inflict damage to the system and/or the plant. Therefore, current practice does not satisfy the requirement to provide a stand-by water injection system free from gas bubbles at all times. Frequently, plant operators use ultrasonic equipment to detect (“see”) if certain parts of the system harbor gaseous products, that is, in areas where venting valves have not been installed. Ultrasonic equipment is expensive to acquire and operate because it requires trained personnel. Part of the problem is associated with the cost of installation of current version vent valves, venting labor costs, and venting valve maintenance costs.

The status of this issue is summarized in a U. S. Nuclear Regulatory Commission (NRC) Generic Letter (GL) 2008-01 publicly available in the web site: nrc.gov. Many relevant references are cited in that GL. This document is incorporated by reference herein for its details on nuclear power plant stand-by safety systems.

### BRIEF SUMMARY OF THE INVENTION

This invention provides a venting-valve/check-valve combination useful for venting gases in a liquid pipeline comprising a venting-valve, a check-valve, and a capillary port through which gases can pass, said port having two openings, each valve controlling the opening and closing of one of said openings.

In preferred aspects, the capillary port comprises a gas passageway having an axis in the direction of gravity; the venting-valve is adapted to be positioned between a liquid pipeline and one opening of said port and said check-valve is positioned at the other end of said port; the venting-valve comprises a valve seat having a shape and a sealing element which has a complimentary shape such that when it presses against said seat, the valve is closed, said sealing element being of a volume and weight such that it floats in the liquid in the pipeline under normal and anticipated temperature and pressure conditions in the pipeline (including but not limited to 70 to 250° C. and up to 2200 psi) and is effective to close said valve in said pipeline without substantial deformation; the check-valve comprises a valve seat having a shape and a sealing element which has a complimentary shape such that when it presses against said seat, the valve is closed, said sealing element being of a volume and weight such that under gravity and the expected conditions of temperature and pressure in said pipeline, said check-valve is closed; and/or when connected to said pipeline the combination valve is adapted such that said floating sealing element floats to seal said venting-valve.

In another aspect, the invention relates to a liquid pipeline having connected thereto one or more combination valves described above, where, preferably, the liquid is water; the liquid pipeline is part of a stand-by safety system of a nuclear power plant; the valve(s) is/are mounted to said pipeline by a bolt-like housing; and/or the combination valve is mounted on the highest elevation of the pipeline.

In another aspect, the combination valve further comprises cylindrical openings in which the sealing elements of the check-valve and the vent-valve are situated and move in the direction of gravity of said cylindrical openings, the axis having ends which contact the valve seats of the check and vent-valves, respectively; the valve seats comprise semispherical surfaces, the sealing elements are spherical and the port is in the direction of gravity; and/or the cylindrical opening of the check-valve is inclined with respect to the axis of the venting-valve, said axis being vertical.

In another aspect, a nuclear power plant comprises a stand-by system comprising a liquid pipeline of this invention.

In another aspect, a method of venting gases from a water pipeline which is part of a stand-by system of a nuclear power plant comprises placing said pipeline in communication with a valved venting port which has a capillary opening.

This invention attains reliability through simplicity, small size, inexpensive construction, installation, operation and redundancy. Low cost and redundancy are significant factors in attaining high reliability.

Thus, this invention pertains to a venting-valve/check-valve combination designed to vent gases whenever such gases concentrate in emergency stand-by systems in power plants and in nuclear plants in particular. Operation of the proposed system is based on viscosity and density differences in water and gases. The vent valve open-close function is based on buoyancy. Venting is achieved through a small diameter channel (capillary) size. The proposed venting system is fail-safe because: if the vent fails in the open position the amount of water leakage in very small (due to viscosity differences) and is inconsequential for the operation of the plant. If the valve fails, in the closed position redundant valve(s) will continue to vent. The probability of total failure is vanishingly small. The proposed venting system assures that the emergency response system will be free of gases at all times and offers ready access to attach an exhaust gas measuring device.

This invention pertains to a venting-valve, check-valve combination that is able to continuously vent gaseous products from an emergency stand-by system in nuclear power plants.

The proposed venting-valve/check-valve combination presents the following advantages compared to the venting valves of current practice:
Can be fabricated at a small fraction of the cost of current venting valves.
Installation requires a small fraction of the time and labor compared to current venting valves.
The proposed valve does not require maintenance other than periodic inspection to assure it is in working order.
The proposed valve works automatically without operator intervention.
The proposed valve has a fail-safe mode of operation.
The proposed valve eliminates the need for expensive equipment (and associated labor) to identify the water level in the system piping and components such as ultrasound. Due to the low cost of acquisition and installation, redundant (or multiply redundant) units may be installed in locations where gaseous bubbles may be formed.
The proposed valve keeps the system gas bubble free at all times in compliance with the intent of the regulations.
The low cost of acquisition, installation, and operation are important factors in increased functional reliability.

The vent-valve check-valve combination of this invention is ready to attach to exhaust gas measuring devises. Measuring exhaust gaseous products is desirable but using the current venting valves is cumbersome and expensive that inhibits its use. In many instances it is necessary and/or desirable to quantify gas accumulation and/or gas rate production in certain parts of the system. Gas accumulation or accumulation rate could be used as a diagnostic tool, indicating system sip-in, steam production, or other abnormal conditions.

Similar phenomena to those mentioned above for nuclear power plants occur in conventional power plants; therefore, this invention could be applied in conventional power plants as well and in general to any liquid pipeline or storage system.

### BRIEF DESCRIPTION OF THE DRAWINGS

In order that the invention may be more readily understood, there is described by way of non limiting examples particular embodiments of this invention with reference to the accompanying drawings.

FIG. 1 shows a piece of pipe (chosen for the purpose of demonstration) from which two plugs have been removed for the installation of the degassing valve of this invention. The axis of both plugs is in the direction of gravity and both are preferably located in the highest elevation point of the system (overall or local). G in FIG. 1 designates the direction of gravity and α and β show plug-cuts shown in circumferential and axial direction of the pipe respectively. FIG. 3 (7) shows that the hole for the installation of the vent-valve assembly is preferably not drilled through the entire thickness of the pipe. This creates a thin ledge to support an O-ring FIG. 3 (8) to provide water and air-tight fit of the vent-valve assembly.

FIG. 2 shows a diagrammatic representation of an installed check-valve, venting-valve assembly; venting-valve and cheek-valve seats (9 and 10 respectively) and the corresponding spheres (4 and 2 respectively) constitute the moving part of the valves. Both valves are shown in the closed position. This representation includes the threaded side (6) of the valve housing (1) installed into the (tapped) hole shown in FIG. 1. FIG. 2 also illustrates an intake channel (5) covered with screen (5a) with mesh size less than the venting channel diameter and formed in a slight wavy manner as shown in FIG. 3A with ridges and valleys perpendicular to the direction of flow. If there would ever be a piece of debris in the water flow in contact with the screen it would likely get caught in the front side and leave the back side of the screen free so the vent valve would continue to function. Venting channel exit (12) is also shown with screen (12a) formed with the same mesh size as screen (5a). Housing (1) is threaded (6) in its entire length. Venting channel (3) is a small diameter hole (capillary) such that water flow is severely limited while gases may vent.

FIG. 2 also shows that the valve housing has outside threads, therefore; it is equipped with appropriate holes (11) to act as screwdriver-holds for installation of the assembly.

FIG. 3 shows the detail of the preferred support ledge (7) for the insertion and hold down of a metallic O-ring (8) to assure water and air tight installation.

FIG. 4 shows another diagrammatic representation of this invention. The main difference between FIG. 4 and FIG. 1 is that in FIG. 4 the check-valve sphere is situated in a tilted channel (angle θ with the vertical) so that the check-valve will allow gas venting with a small system pressure differential with respect to atmospheric pressure.

FIG. 5 shows calculated volume rates of the gaseous product and water exiting from the venting valve as a function of venting channel diameter and pipe (system) pressure in psi. The calculation was carried out using Poiseuille's equation of flow, using nitrogen viscosity as a surrogate for the potential combination of the gases. The flow rates represent volumes under the pressure and temperature conditions of the system.

This invention thus relates to a venting-valve check-valve combination specifically adapted to automatic venting of gases from nuclear power plant stand-by emergency core cooling systems. System operation is based on density and viscosity differences between air and water.

For this invention it is preferred that the venting valve be: (a) installed in the local highest elevation point(s) of the subject standby system and (b) that the valve is installed in a cylindrical hole with vertical axis such that the venting channel is in the direction of gravity. It should be noted that a stand-by system could have more than one high point(s) because the piping that conveys water from pump suction to the vessel injection point may go through various elevations that create local high (elevation) points; each should be vented separately.

According to this invention, there is a housing having an inlet connecting the inside volume of a plant's stand-by emergency response system to a vent channel connecting said inlet to an exit outlet and check-valve to the atmosphere or to a gas measuring device. An important feature of this invention is the small diameter (capillary) size of the venting channel to vent sufficient gaseous products to eliminate the gas bubble but expelling only an inconsequentially small amount of water if it fails in the open position. If the venting valve was to fail in the closed position redundant valves would continue to carry out the venting function. Failure in the open or closed position would be an extremely unlikely event. Therefore, the proposed system of this invention can be called fail-safe. Typical capillary channel diameters will include 0.5 to 3.0 mm, preferably about 1.0 mm.

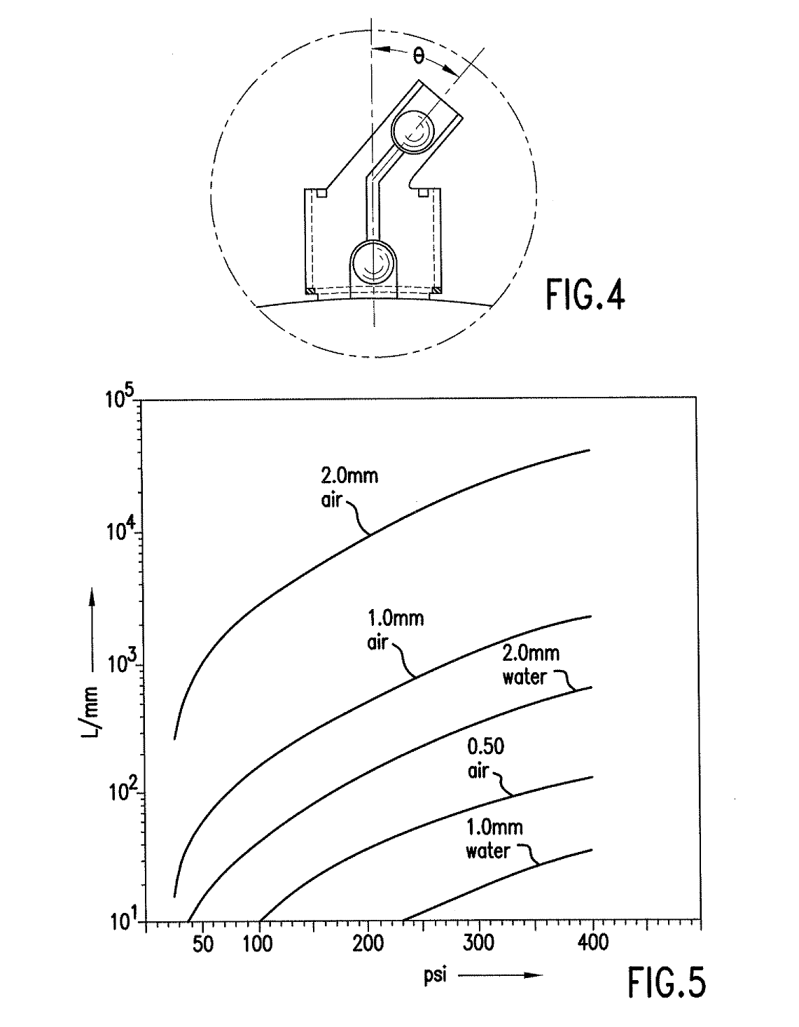

The venting valve is formed by a floating sphere (or other suitable shape such as conical, cylindrical, etc.) and a corresponding valve seat that forms an air-tight and water-tight closure when the standby system is full of water and the valve is in the closed position. When an air bubble forms in the area of the vent valve, the sphere will move lower allowing the venting process to take place. Normally, the inside of the stand-by system is in higher pressure than atmospheric, which will displace the check valve and allow venting. However, if the inside pressure of the stand-by system is lower than atmospheric, the check valve will not allow ingress of atmospheric air. Screen (5a) provides support for sphere (2) and defines its range of motion. Screen (5a) is designed from rust proof and decay or deterioration resistant material. Screen (5a) also has a slightly wavy construction FIG. 3A with peaks and valleys in a 90 degree angle with the direction of flow. Thus, if there is debris in the flow, it will most likely get caught on the side facing upstream while the opposite face will remain free of debris and able to vent gaseous products.

It may further be preferred that instead of using a spherical shape to close the venting-valve assisted by buoyancy, a conical, flat or other suitable shape can be used. In addition, instead of buoyancy being the motive force for the operation of the venting valve, electromagnetic forces can be used, activated by a signal generated by a suitable probe in the presence of water.

It is further preferred to form a cylindrical guide channel at the valve exit with its axis tilted with respect to the direction of gravity, e.g., by angle θ, e.g., 30 to 60 degrees See FIG. 4. In this manner the element retains its ability to prevent air intake while it moves more easily away from the valve exit to allow exhaust of the system's gases. This will assure that the check valve will allow the exit of gases in case the pressure of the system is slightly higher than atmospheric pressure.

It is preferred that the valve assembly housing be formed as a bolt so that it may be readily installed in the tapped hole envisioned in section [023]. The valve assembly when installed is even with the inside surface of the pipe.

It may also be preferred that the outer threading of the housing be extended on its entire surface so that gas measuring devices or equipment can be fastened on it when and if it is desired to measure the volume of the extracted gases or their flow rate.

It is also preferred that the venting channel should it ever be plugged by debris, be readily unplugged by inserting an appropriate size (diameter and length) flexible wire-like probe through the venting channel. In order to facilitate insertion of the cleaning probe, screen (12a) and sphere (4) of the check valve can be temporarily removed. The cleaning probe should have the exact length as not to interfere with sphere 2 of the venting valve. Debris obstructing the venting channel is highly unlikely because high pressure venting would automatically clean the venting channel should it be obstructed.

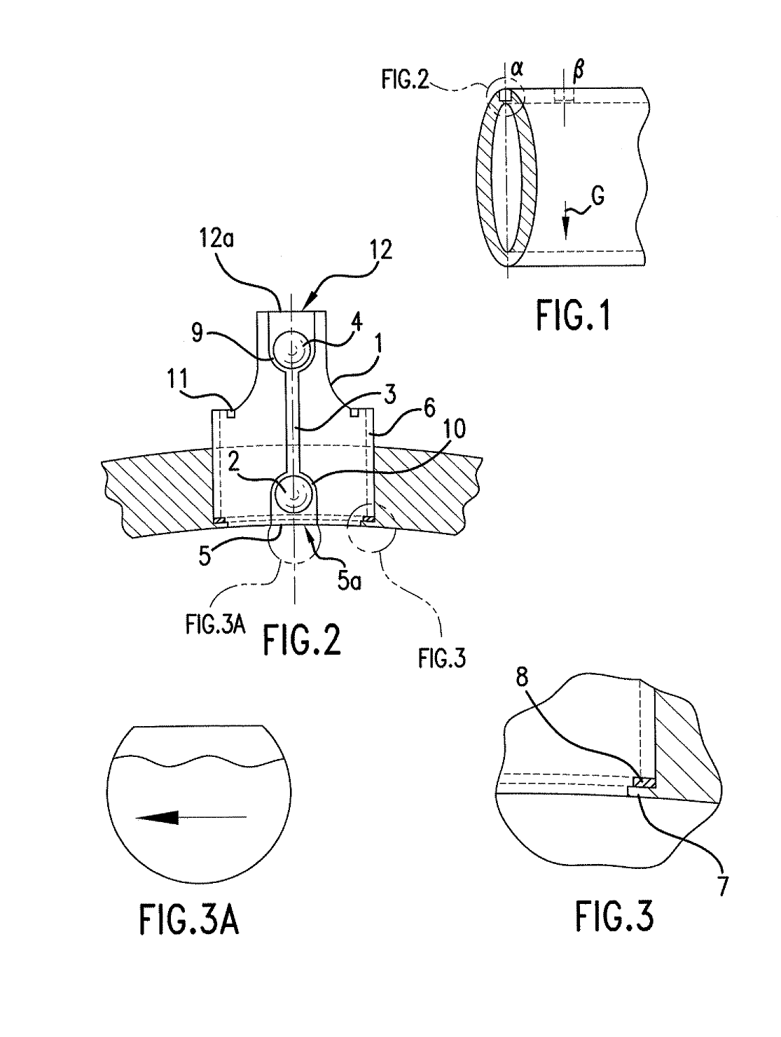

It is envisioned that installation of the vent-valve assembly of this invention will require a minimum of time and effort and be implemented on or off-line. If the plant is on-line, the system chosen for this installation should be isolated. The hole(s) shown in FIG. 1α and 1β will be drilled and threaded to the proper depth and the valve assembly installed. Clearly, this process presupposes that proper size and type of a prefabricated valve assembly will be ready for installation. This process is possible because there exists a second operable standby system; thus, the first can be taken off line for a short period of time. Testing of the installed valve assembly can take place with a temporary re-pressurization of the isolated part of the system.

The venting valve sphere or other element is engineered and fabricated to fulfill the following requirements: (a) the volume to weight ratio is such that it floats in water or other liquid with temperatures and pressures encountered in the systems of interest, and (b) it should not lose its shape and integrity at the expected highest operating system temperature and pressure (including but not limited to 250° C. and up to 2200 psi.). Check valve 4 (FIG. 2) is engineered and fabricated to be as light-weight as possible. The material could be metallic or non metallic. Suitable materials include aluminum, aluminum alloys or high strength light metals like titanium.

As can be seen, low fabrication and installation cost, small size, maintenance free operation, continuous venting, fail safe operation, elimination of the need for expensive diagnostic equipment, redundancy and high cost to benefit ratio are important advantages of this invention. In the invention, a venting-valve check-valve system can be mounted on a bolt-like housing, prefabricated and ready to be installed on nuclear power plant stand-by safety systems to vent potential accumulation of gases. Installation should be on the highest elevation (or local highest elevations) of the system in a direction such that the longitudinal axes of the venting channel is in the direction of gravity. The venting valve consists of a sphere and a valve seat at the lower end of the venting channel that is in the direction of gravity. The sphere part of the venting valve is designed to float in water or other liquid of the temperature and pressure encountered in standby safety systems. The sphere part of the venting valve is designed to withstand the maximum system pressure without deformation (including but not limited up to 2200 psi). When the water/liquid level is at or above the level of flotation of the sphere, and the sphere is at its highest elevation, the venting valve is in the closed position. The check valve closes the upper part of the venting channel and normally seats by gravity on the valve seat forming a check valve for air to enter the system. The sphere of the check valve can be made out of metallic (or possibly non metallic) material to be as lightweight as possible. The sphere part of the check valve as well as of the vent valve are situated and move in the up and down direction in cylindrical openings that end in the upper end and the lower end in a semispherical surface for the vent valve and the check valve, respectively. The venting channel connects the upper most and lowest points of the semispherical surfaces and is designed and installed to be in the direction of gravity. The seat of the vent-valve and the check-valve can be the surface in the lower and upper hemispheres respectively. The hemispherical-cylindrical channel of the check-valve can be inclined with respect to the vertical. The vent-valve and the check-valve can be mounted on a bolt like structure a “valve assembly” that is installed on a suitably located and suitably oriented hole in the piping or other structural components of the system. The valve assembly is preferably prefabricated and ready for installation. This installation can be facilitated by suitable notches on the upper part of the valve assembly for the use of a screwdriver tool. Another preferred feature of this invention is that the valve assembly extends above the surface of the equipment on which it is fastened. This part has continuity of the threading used for its installation and may be used to fasten suitable equipment to measure the vented gas (or gas venting rate) fasten gas collection equipment for gas evaluation.

From the foregoing description, one skilled in the art can easily ascertain the essential characteristics of this invention and, without departing from the spirit and scope thereof, can make various changes and modifications of the invention to adapt it to various usages and conditions.

I claim:

1. A venting-valve/check-valve combination useful for venting non-condensable gases and steam, or a combination thereof in a liquid pipeline comprising a venting-valve, a check-valve, and a capillary port through which gas can pass, said port having two openings, each valve controlling the opening and closing of one of said openings.

2. A combination valve of claim 1 wherein said capillary port comprises a gas (or liquid) passageway having an axis in the direction of gravity.

3. A combination valve of claim 2 wherein said venting-valve is adapted to be positioned between a liquid pipeline and one opening of said port and said check-valve is positioned at the other end of said port.

4. A combination valve of claim 3 wherein said venting-valve comprises a valve seat having a shape and a sealing element which has a complimentary shape such that when it presses against said seat, the valve is closed, said sealing element being of a volume and weight such that it floats in the liquid in the pipeline under normal and anticipated temperature and pressure conditions in the pipeline and is effective to close said valve in said pipeline without deformation beyond the elastic limit of the material.

5. A combination valve of claim 3 wherein said check-valve comprises a valve seat having a shape and a sealing element which has a complimentary shape such that when it presses against said seat, the valve is closed, said sealing element being of a volume and weight such that under gravity and the normal conditions of temperature and pressure in said pipeline, said check-valve is closed.

6. The combination valve of claim 5 which when connected to said pipeline is adapted such that said floating sealing element floats to seal said venting-valve.

7. A liquid pipeline having connected thereto one or more combination valves of claim 6.

8. A liquid pipeline of claim 7 wherein said liquid is water.

9. The liquid pipeline of claim 8 which is part of a stand-by safety system of a nuclear power plant.

10. The liquid pipeline of claim 7 wherein said valve(s) is/are mounted to said pipeline by a bolt-like housing.

11. The liquid pipeline of claim 9 wherein said combination valve is mounted on the highest elevation thereof.

12. The combination valve of claim 5 further comprising cylindrical openings in which the sealing elements of the check valve and the vent-valve are situated and move in the direction of gravity of said cylindrical openings, the axis having ends which contact the valve seats of the check and vent-valves, respectively.

13. The combination valve of claim 12 wherein the valve seats comprise semispherical surfaces, the sealing elements are spherical and the port is in the direction of gravity.

14. The combination valve of claim 12 wherein the cylindrical opening of the check-valve is inclined with respect to the axis of the venting-valve said axis being vertical.

15. A nuclear power plant comprising a stand-by system, comprising a liquid pipeline of claim 9.

16. A method of venting non-condensable gases or steam from a water pipeline which is part of a stand-by system of a nuclear power plant comprising placing said pipeline in communication with a valved venting port which has a capillary opening.
